(19) United States
(12) Patent Application Publication
(10) Pub. No.: US 2022/0135434 A1
(43) Pub. Date: May 5, 2022

(54) RAPID ENZYME ACTIVITY MEASUREMENT SYSTEM AND METHOD

(71) Applicant: KING ABDULLAH UNIVERSITY OF SCIENCE AND TECHNOLOGY, Thuwal (SA)

(72) Inventors: Babar Khalid KHAN, Kingston, NY (US); TorOve LEIKNES, Thuwal (SA)

(21) Appl. No.: 17/430,531

(22) PCT Filed: Feb. 24, 2020
(86) PCT No.: PCT/IB2020/051555

§ 371 Date: Aug. 12, 2021

Related U.S. Application Data
(60) Provisional application No. 62/821,017, filed on Mar. 20, 2019.
(60) Provisional application No. 62/828,538, filed on Apr. 3, 2019.

(51) Int. Cl. C02F 1/00; C02F 1/44

(52) U.S. Cl. CPC C02F 1/008; C02F 1/441; C02F 1/445; C02F 2303/20; C02F 2209/36; C02F 2301/046; C02F 2209/003

(57) ABSTRACT

An autonomous and independent biofouling detecting system for detecting biofouling associated with a plant membrane based on a test membrane. The biofouling detecting system includes the test membrane, which shares a feed with the plant membrane; a molecule detecting sensor that detects a presence of a molecule associated with biofouling of the test membrane; and a global controller that controls a flow of the feed through the test membrane and determines when the test membrane needs cleaning.

### CROSS-REFERENCE TO RELATED APPLICATIONS

This application claims priority to U.S. Provisional Patent Application No. 62/821,017, filed on Mar. 20, 2019, entitled “AT-LINE RAPID ENZYME ACTIVITY MEASUREMENTS USING RECIRCULATION AND AN ONLINE FLUOROMETER FOR ASSESSMENT INSIDE A SAMPLING MODULE,” and U.S. Provisional Patent Application No. 62/828,538, filed on Apr. 3, 2019, entitled “RAPID ENZYME ACTIVITY MEASUREMENT SYSTEM AND METHOD,” the disclosures of which are incorporated herein by reference in their entirety.

### BACKGROUND

### Technical Field

Embodiments of the subject matter disclosed herein generally relate to a system for enzyme activity detection, and more specifically, to a system that samples a fluid feed for early detection of biofouling in a feed processing plant.

### Discussion of the Background

As the global population is projected to further increase over the next decades, the water and energy required for domestic, agricultural, and industrial consumption of the increased population is also expected to increase, all of which will ultimately rapidly diminish the existing global water supply. With water use expected to grow by twice the rate of population growth, a 2013 United Nations report estimates that by 2050 most countries around the world will experience water stressed conditions. Thus, a real need exists to discover alternative sources of water and adopt stricter water reclamation processes in safe, economical and efficient ways. According to a United States Geological Survey report, approximately 97% of the Earth's water is saline, and as such, a water filtration technology becomes necessary for opening up previously unusable water sources.

The desalination process removes minerals from saline water, such as seawater, to produce water that is suitable for human or agricultural uses. Most of the interest in desalination focuses on production of fresh water for consumption and is particularly of interest in areas where seawater is abundant, but fresh water sources or rainwater may be limited. However, desalinating seawater can be costly because a large amount of energy is consumed in the process.

There are a number of known approaches for desalinating the water, including distillation and evaporation. The most prevalent approach is the use of reverse or forward osmosis membrane filtration utilizing membranes that allow water to permeate through the membrane while preventing minerals and salts from passing through the membrane. However, the minerals and salts tend to stick to the membrane and also to provide a fertile ground for bacteria growth, which results in membrane biofouling. Membrane biofouling usually reduces the capacity of the membrane to clean the water. Severe biofouling of the membrane can render such membrane inoperative.

Current methods that perform membrane cleaning rely on measuring physical changes of the membrane and correlating the changes to specific operational parameters of the membrane. For example, a reduction of the permeate yield by 10% or an increase in either the feed pressure or trans-membrane pressure (TMP) by ˜15% prompts a cleaning process of the membrane. These measured physical parameters have been linked to increased microbial quantities and metabolic activity. Operational changes of the membrane, resulting from bacterial biofouling, are often caused by the maturation of bacterial communities, which are inherently tolerant to cleaning mechanisms, resulting in poor restoration of the membrane function with current approaches.

Biofouling is defined as being the gradual accumulation of organisms on surfaces (e.g., membrane) to the detriment of the function of the surface, and of particular relevance herein are those organisms that produce biofilms. Biofilm formation is caused by the accumulation of microorganisms and extracellular polymeric substances (EPS) produced by these microorganisms. Biofilms can form on a variety of surfaces including membranes (e.g., in membrane filtration systems), heat exchangers, medical devices, paper manufacturing systems, food processing systems, and in underwater construction. Biofilm formation, which occurs frequently in membrane filtration systems, causes biofouling, which is an unacceptable decline in membrane performance. Additionally, a hydrodynamic boundary layer generally exists adjacent to the biofilm, which reduces the flow of the feed water over the biofilm, thereby decreasing the ability of the feed water to dislodge the biofilm.

One means of using the bacterial catabolism to determine bacterial presence is through assaying the fluid medium associated with the membrane for extracellular enzyme activity. Bacteria use enzymes to breakdown substances in the environment to produce materials required for their metabolic processes. These enzymes are either associated with the bacterial membrane or secreted by the bacteria into the bacterial environment and can be detected in the fluid medium around the bacteria. One of the assays useful for detecting theses enzymes uses fluorescing chemicals, such as fluorogen-substrates, to determine the amount of bacterial activity present by measuring the level of fluorescence produced from cleavage of the fluorogen-substrates by the extracellular enzymes.

However, the existing methods for determining the biofouling of the membranes are slow to recognize when the membrane needs to be cleaned, require the intervention of the operator for performing the testing, which is prone to mistake and delays, and the test itself is slow.

Thus, there is a need for a new system and method that can rapidly and repetitively perform the membrane fouling testing, with minimal human intervention, in an efficient and cheap way.

### SUMMARY

According to an embodiment, there is an autonomous and independent biofouling detecting system for detecting biofouling associated with a plant membrane based on a test membrane. The biofouling detecting system includes the test membrane, which shares a feed with the plant membrane, a molecule detecting sensor that detects a presence of a molecule associated with biofouling of the test membrane, and a global controller that controls a flow of the feed through the test membrane and determines when the test membrane needs cleaning.

According to another embodiment, there is an autonomous and independent biofouling detecting system for detecting biofouling associated with a plant membrane. The biofouling detecting system includes a test membrane that shares a feed with the plant membrane, a molecule detecting sensor that detects a presence of a molecule associated with biofouling of the test membrane, and a global controller that controls a flow of the feed through the test membrane and generates an alarm when the test membrane needs cleaning.

According to still another embodiment, there is a method for determining when a plant membrane needs cleaning. The method includes directing a feed, simultaneously and in parallel, to a test membrane and a plant membrane, configuring plural valves to fluidly insulate a loop from the feed, and detecting with a molecule detecting sensor a presence of a molecule associated with biofouling of the test membrane. The loop includes the plural valves, the molecule detecting sensor, a dosage device, and a pump.

According to still another embodiment, there is a non-transitory computer readable medium including computer executable instructions, wherein the instructions, when executed by a processor, implement instructions for membrane testing as discussed above.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic illustration of a feed processing plant and associated biofouling sensor;

FIG. 2 is a schematic illustration of the biofouling sensor;

FIGS. 3A and 3B illustrate a process by which the bacteria chemically break-down surrounding molecules into smaller components;

FIGS. 4A and 4B illustrate underlying chemical reactions between fluorogen-substrates and molecules generated by the presence of the bacteria;

FIG. 5 illustrates a biofouling detecting system 500 that is used in a feed processing plant for estimating when a plant membrane needs to be cleaned;

FIG. 6 illustrates the detection of a fluorogen material in the biofouling detecting system at various stages;

FIG. 7 illustrates a method for detecting a biofouling of a plant membrane with a biofouling detecting system;

FIGS. 8A to 8D illustrate various stages of a biofouling detecting system;

FIG. 9 illustrates another biofouling detecting system for detecting biofouling in a feed processing plant;

FIG. 10 is a flowchart of a method for detecting biofouling of a plant membrane; and

FIG. 11 is a schematic diagram of a computing device that implements the novel methods discussed herein.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a biofouling detecting system that automatically and autonomously analyzes a feed that is processed in a plant and detects when a membrane that processes the feed in the plant needs to be cleaned out, and/or replaced, due to biofouling. The biofouling detecting system includes plural valves, which are controlled by a global controller, a reagent supply reservoir, a pump, and a molecule detections sensor. The biofouling detecting system is fluidly connected to an actual plant that uses at least a membrane for water treatment purposes (e.g., desalinization). The global controller opens and closes the plural valves of the biofouling detecting system, according to a certain sequence, for fluidly insulating the system from the plant, inserting a reagent for inducing a chemical reaction of enzymes with the reagent, analyzing a signal generated by the formed compound, flushing the system of the reagent and byproducts, and fluidly connecting back the system to the plant. All these operations are controlled by the global controller and does not require human intervention. In one variation of this embodiment, only a subset of the steps noted above are implemented by the global controller.

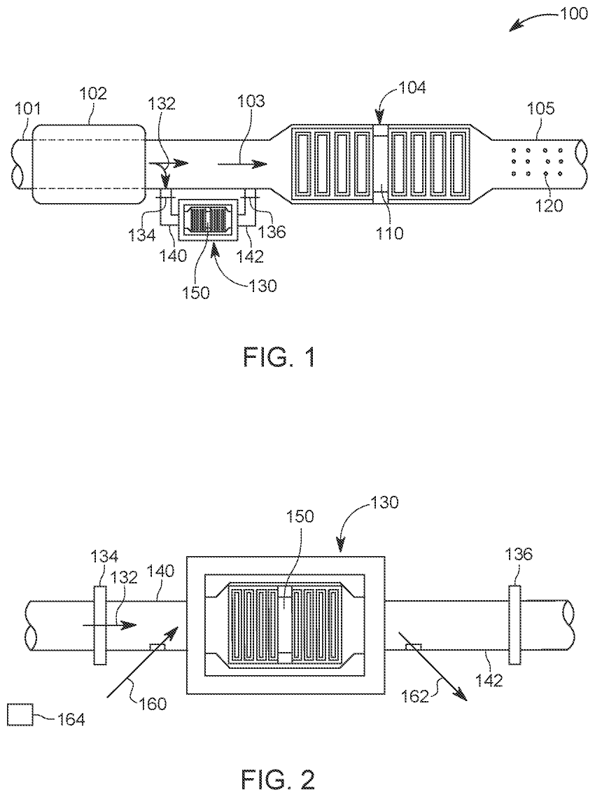

FIG. 1 schematically illustrates a fluid treatment plant 100 that uses a filtration unit 104 for removing minerals and/or salts from a fluid feed 103 (this system is similar to the system disclosed in International Patent Application No. PCT/IB2017/055042, which is assigned to the assignee of this application, and is incorporated in its entirety herein). The filtration unit 104 may involve any known technology and the impurities and/or salts may include any known organic or inorganic material that is desired to be removed from the feed 103. The feed is first provided at an inlet 101 of a pretreatment unit 102, which is located upstream of the filtration unit 104. The feed 103 flows then into the main filtration unit 104 and interacts with a plant membrane 110. In this way, the feed 103 experience desalinization. The desalinated water, or permeate 120, exits via permeate outlet 105.

The membrane stops the various minerals and/or salts from the feed to generate the permeate 120. However, during this process, as discussed above, the membrane is involved in a biofouling process. To determine when this process negatively impacts the membrane, so that a cleaning stage or replacing of the membrane is necessary, a biofouling detecting system 130 is employed. The biofouling detecting system 130 is fluidly connected to the feed 103 so that part of the original feed is diverted as indicated by arrow 132 into the biofouling detecting system 130. The biofouling detecting system 130 has an inlet valve 134 and an outlet valve 136, which control the flow of the feed into the system 130. When the inlet valve 134 and the outlet valve 136 are open, the feed flows through the main filtration unit 104, but also through the biofouling detecting system 130, as illustrated in FIG. 1. The feed flows along the inlet conduit 140 and out of the system along outlet conduit 142. The deviated part of the feed then returns back to the main feed 103, thus allowing the biofouling detecting system's membrane 150 to experience the same feed conditions as the plant membrane 110 of the main filtration unit 104.

This type of biofouling detecting system that is placed in parallel to the plant's main filtration unit for experiencing similar conditions is called herein an at-line system or sensor. The biofouling detecting system 130 shown in FIG. 1 may utilize a fluorogen-substrate based Extracellular Enzyme Activity (EEA) assay for early detection and quantification of bacterial activity based on the presence of bacterial extracellular enzymes present in the fluid medium around the membrane 150. The quantification of the bacterial activity associated with the membrane 150 would be assumed to be similar to that of the plant membrane 110, which means that when the membrane 150 is found to be in need of a cleaning procedure or replacement, the plant membrane 110 would also need to receive the same treatment. In other words, instead of monitoring or measuring directly the biofouling of the plant membrane 110 that is at the heart of the plant 100, this embodiment monitors a “sister” membrane 150, which is supposed to experience the same conditions as the plant membrane 110, and whatever biofouling is found for the sister membrane 150, the same is assumed to be the case for the plant membrane 110. In addition, the “sister” membrane may experience fouling earlier due to its scale, which can be correlated to a future fouling event on the plant membrane based on predictive analysis. In other words, the system membrane may behave like a canary in a mine, i.e., can predict a future fouling event of the plant membrane. Predictive software and/or historical data may be used to correlate the time delay between the sister membrane fouling and the plant membrane actual fouling. Thus, when the sister membrane fouling is detected, the global controller is able to inform the operator of the plant that the plant membrane would need to be acted upon in the next x days, where x is determined by the predictive software. The value of x can take any value.

The biofouling detecting system shown in FIG. 1 is useful for detecting and quantifying membrane biofouling used at-line adjacent to a water filtration system, but the same biofouling detecting system can be used in other applications where biofouling may occur. The detecting system described herein is particularly advantageous when used in water desalination systems. Although reverse osmosis membrane and forward osmosis membrane filtration systems are the most efficient systems for water desalination, the detecting system disclosed herein may be used with other types of membrane filtration systems that are subject to biofouling. In addition, the proposed mechanism can be used for sampling and monitoring of any detectable reactant that is a byproduct of reagent and reagent-acting material. Hence, the system may be deployed for monitoring completely artificial systems with compatible reagent, agent reacting on the reagent, and detectable reactant.

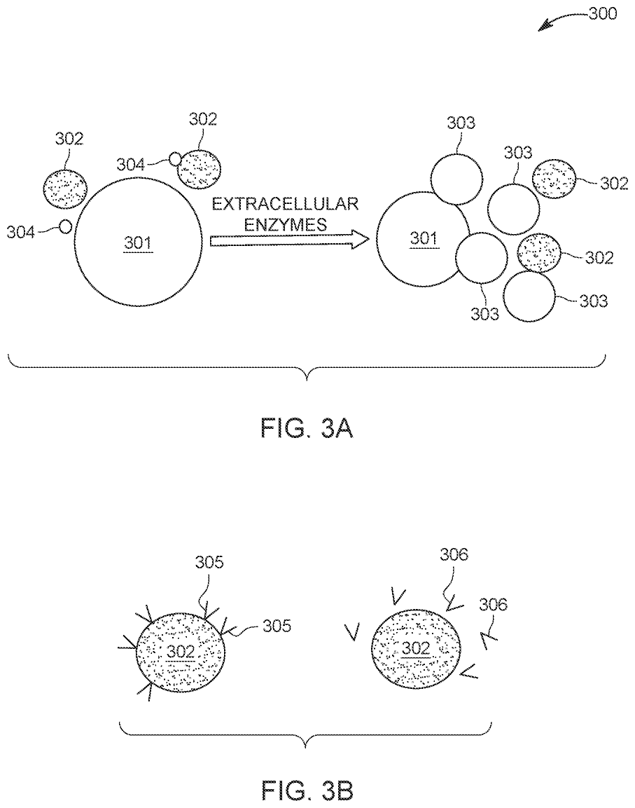

FIG. 2 shows in more detail the at-line biofouling detecting system 130 for monitoring a membrane health. EEA measurements obtained with the biofouling detecting system 130 are used to measure bacterial dynamics on membrane 150 associated with seawater desalination systems within a closed system. To achieve this closed system function, the feed flow is linear, with an adjustable flow range from 1.5-20 liters per hour. Due to the construction, the system can be operated at temperature from 0-70° C. and pressure ranges from 0-70 bar. The biofouling detecting system is capable of measuring biofouling growth over time in a range of configurations commonly found in the desalination process.

Following the schematic in FIG. 2, the inlet valve 134 and outlet valve 136 of the at-line biofouling detecting system 130 can be closed at set time points for gauging bacterial EEA without interrupting operation of the plant membrane 110 of the main filtration unit 104. Once valves 134 and 136 are closed, a selected fluorogen-substrate can be injected by the operator of the system into the at-line biofouling detecting system 130 through an injection port 160. Following an incubation period, aliquots are removed then by the operator via the sample (flush) port 162 and these samples are read externally at a fluorometer 164. Alternatively, liberated fluorogens from the EEA assay can be detected using an online fluorometer. After testing, which typically lasts no more than 30 minutes, the biofouling detecting system 130 is flushed of residual fluorogens and byproducts by flushing materials, which are injected into the biofouling detecting system 130. These byproducts are taken out through the sample (flush) port 162. After flushing is completed, the inlet valve 134 and outlet valve 136 are reopened and the feed stream 132 passes again through the inlet conduit 140 to the biofouling detecting system 130 and flows via outlet conduit 142 to the main feed 103 as before. At each set time point, 30 minutes of fluorogen-substrate incubation was selected as a balance between realistic sampling time and resulting signal strength; however the dwell time of the fluorogen-substrate in the sensor can range from 1 minute to 60 minutes, as needed for the testing parameters. Increasing the incubation time should result in an increased signal strength as more fluorogen liberation can occur.

The at-line biofouling detecting system 130, which is positioned adjacent to the main filtration unit 104, and not in the main feed stream flow, is open to manipulations that are not possible for on-line systems. Conditions such as pH and temperature can be adjusted during the measurement stage or other stages. For example, adjusting the pH can be accomplished during testing by injecting the fluorogen-substrate in either an alkaline or acidic solution, depending on the parameters required for the specific fluorogen-substrate being used. Similarly, enclosing the sensor inside a temperature-controlled cabinet can control the temperature to levels that are not possible with the main filtration unit. The optimal temperature and pH differ depending on the specific combination of the fluorogen-substrate and matrix (e.g., seawater or drinking water) being processed in the membrane filtration system, and the system of FIGS. 1 and 2 is able to accommodate means to achieve the optimal temperature and pH for the assay.

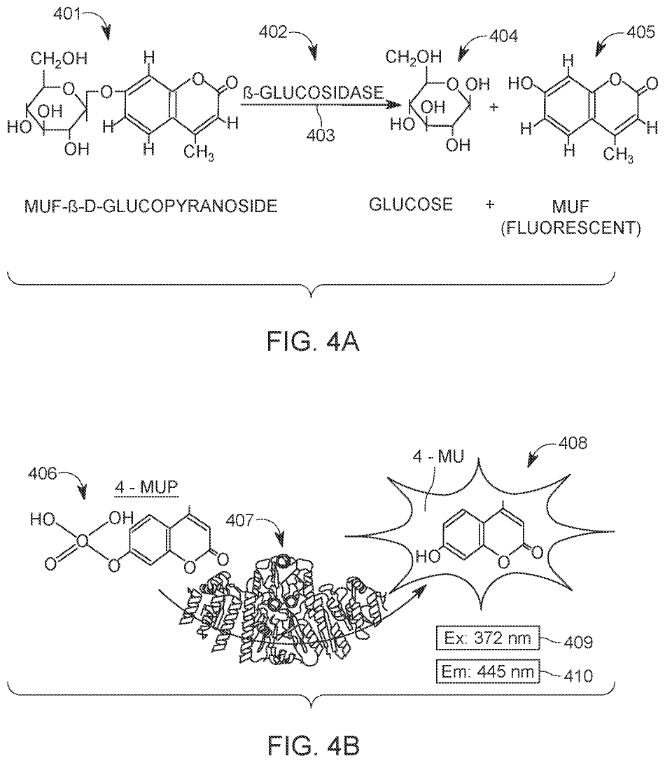

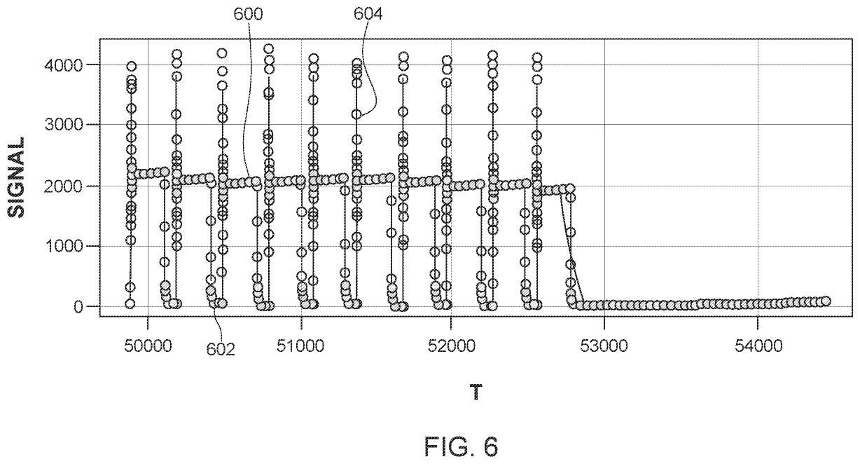

FIGS. 3A and 3B illustrate the hydrolytic cleavage of fluorogen-substrate mediated by extracellular enzymes by bacteria in an aquatic environment 300. Note that neither the fluorogen-substrate nor the extracellular enzymes are by themselves capable of generating a strong signal in a fluorometer. However, the product resulting from the combination of the fluorogen-substrate and the extracellular enzymes generates a strong signal that is detected by the fluorometer. Thus, based on the enzymes that are expected to be found in a given feed processing plant, an appropriate fluorogen-substrate is selected so that the product generated by the interaction of them is highly fluorescent. If the sensor is not a fluorometer, then an alternative substrate would be selected to enhance the specific reaction or process on which the sensor relies. Bacteria 302, when in presence of natural organic molecules 301, that are found in the feed 103, will produce enzymes 304 to breakdown the natural organic molecules 301 (NOM). The action of the enzymes 304 will lead to the production of assimilable molecules 303 that can be used by the bacteria 302 (see FIG. 3A). Enzyme activity can be limited in range to the environment adjacent to the cell membrane because the enzyme 304 can be tethered to the membrane as an ecto-enzyme 305, or can be secreted to act locally in the microenvironment as an exo-enzyme 306 (see FIG. 3B). In essence, bacterial extracellular enzymatic activity increases the conversion of large organic molecules 301 into intermediate molecules 303 in the surrounding environment, which then can be readily transported via active transport into the bacterial cell 302. These enzymes can be detected and quantified with an appropriate system in the fluid medium that surrounds the bacterial cells and provide an indication of the level of bacterial activity. When a fluorogen-substrate is used in the detection assay, the level of measurable fluorescence corresponds to the level of enzyme present in the system. The process illustrates in FIGS. 3A and 3B is used for the biofouling detecting system discussed later with regard to FIG. 5. Before discussing this novel system, a brief discussion of the chemical reactions between the fluorogen-substrate and various enzymes is discussed.

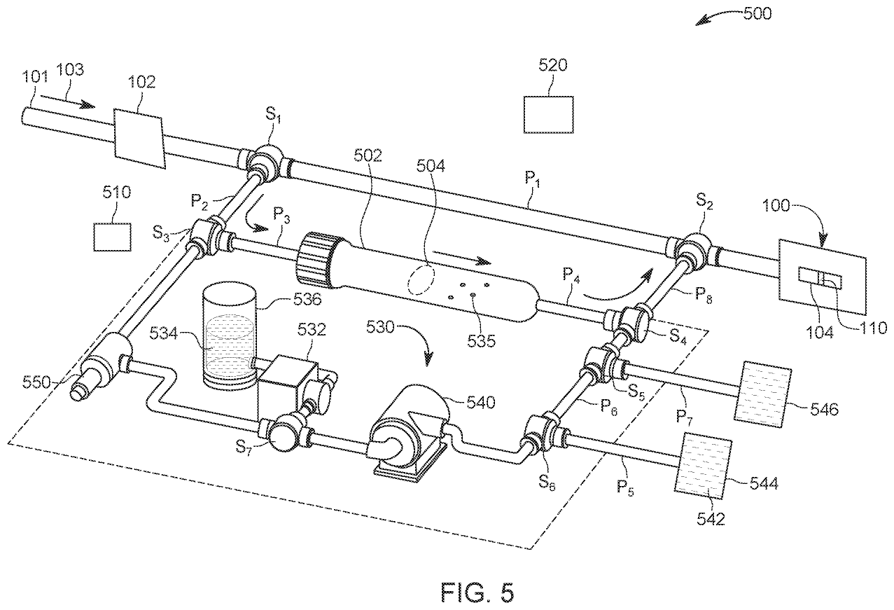

FIG. 4A is a schematic of the fluorogen-substrate enzymatic cleavage. In this example, a hydrolysis reaction 403 of the fluorogen-substrate 401 (MUF-β-D-glucopyranoside) by the hydrolytic enzyme 402 (n-glucosidase) results in formation of a glucose product 404 and a fluorescent product (4-methylumbelliferone (MUF)) 405. In FIG. 4B, another cleavage example shows the fluorogen-substrate 4-MUP 406 being acted on by the ALP enzyme 407 to produce the fluorescent product 4-MU 408. Excitation wavelengths 409 and emission wavelengths 410 are measured and the fluorescence readings can be correlated to the level of extracellular enzyme in the assayed environment.

Along with MUF, three other fluorogens, 7-amino-4-methylcoumarin (AMC), p-nitroanilide (pNA) and β-naphthylamide (β-nap) have been conjugated to unique substrates. However, these newly conjugated fluorogen-substrate molecules have not been fully characterized and MUF conjugates have been found to be the most suitable for the disclosed EEA assay method.

Another biofouling detecting system is now discussed with regard to FIG. 5. The biofouling detecting system 500 may be used in a similar context as the biofouling detecting system 130, i.e., as an at-line detecting system with a feed processing plant. However, the biofouling detecting system 500 may also be used in other contexts where the biofouling of a component of a plant may occur. FIG. 5 shows the biofouling detecting system 500 having a membrane module 502 that hosts one or more membranes 504. The membrane 504 is similar, in terms of configuration and composition, to the membrane 110 used by the filtration unit 104 of the monitored plant 100, but has a smaller size. FIG. 5 schematically illustrates the inlet 101 of the plant 100, and also its pretreatment section 102. Note that the pretreatment unit is optional. The biofouling detecting system 500 has first and second valves S1 and S2, which are attached to the main piping P1 of the plant 100, for diverting a small amount of the feed 103 into the system. In one embodiment, the valves S1 and S2 are solenoid valves, that are supplied with power from a power source 510. The power source 510 may be linked to the power grid that supplies electricity to the plant 100, or it may be an autonomous source. For example, the power source 510 may include a battery, fuel cell, wind turbine, solar cell, etc. The wire connections between the power source 510 and the various valves and other elements of the biofouling detecting system 500 are not shown in FIG. 5 for simplicity.

A global controller 520 is also part of the biofouling detecting system 500 and this controller is used for coordinating the closing and opening of the valves, turning on and off the pumps, controlling a fluorometer, data collection and also for analyzing the collected data, and generating an alarm when the membrane 110 needs to be cleaned or changed. The global controller 520 may be a computer, a processor, or a similar device that can run instructions. The global controller is configured to communicate with the valves and pumps and/or other devices in a wired or wireless manner using any known communication protocol.

While the feed 103 flows from valve S1 to valve S2 along pipe P1, part of the feed is diverted at valve S1 along a pipe P2, to a valve S3. Valve S3, similar to valves S1 and S2, may be a solenoid valve. Each of the valves S1-S3 is a three-way valve in this embodiment. Valve S3 is configured to allow the feed 103 to enter the pipe P3 to move to the membrane module 502. The fluid feed enters the membrane module 502, passes the membrane 504 and then advances along pipe P4 to a fourth valve S4. Valve S4 is similar to valve S3. Valve S4 allows the fluid from pipe P4 to either return to the main line P1, along pipe P8 and via valve S2, or to enter a loop 530 formed by various valves, pumps, and pipes, which is now discussed. This process may be performed with a different configuration that simplify or introduce additional components.

Loop 530 is made of plural pipes, valves, at least one pump and a measurement device. Loop 530 could be fluidly insulated by valves S3 and S4 from the feed 103. When this happens, a dosing device (e.g., dosing pump) 532 injects a reagent 534 stored in a storage device 536, into the loop, through a valve S7. The reagent may be any of the fluorogen-substrates discussed above, when a fluorometric process is employed to estimate the biofouling. However, if another process is used to estimate the biofouling of the membrane 504, then a different type of chemicals may be used. The dosing device 532 may be controlled by the global controller 520 with regard to how much of the reagent 534 is injected into the loop, for how long, and at what time. Valve S7 may be similar to valve S1. In one embodiment, valve S7 may be omitted or incorporated into the dosing device 532.

After the reagent is injected into the loop 530, it is circulated through the entire loop by a pump 540. Pump 540 could be placed anywhere along the loop 530 and is controlled by the global controller 520. In this way, the reagent 534 moves through the piping of the loop 530 and interacts with the biofouling of the membrane 504, and/or with the products (e.g., enzymes) generated by the bacteria responsible for the biofouling of the membrane. After the reagent reacts with the products generated by the bacteria located on the membrane 504, a fluorescent product 535 is generated, as discussed extensively above with regard to FIGS. 4A and 4B. This fluorescent product 535 is forced by the pump 540 to circulate through the loop 530 and eventually enter a molecule detection sensor 550. The molecule detection sensor 550 may be placed anywhere in the loop 530 and is controlled by the global controller 520. In one application, the molecule detection sensor 550 does not need human intervention for generating a reading of the molecules passing by. For this embodiment, the molecule detection sensor is a fluorogen sensor or a fluorometer. This type of sensor is configured to measure one or more parameters associated with the fluorescence of a molecule, i.e., its intensity and/or wavelength distribution of emission spectrum after excitation by a certain spectrum of light. These parameters are used to identify the presence and the amount of specific molecules in the medium. A performant fluorometer is capable of detecting fluorescent molecule concentrations as low as 1 part per trillion. Those skilled in the art would know, having the benefit of this disclosure, that other sensors (e.g., spectrometer) may be used for determining the presence of a molecule in the loop and also for identifying that molecule. Knowing the type and amount of molecule, which is associated with the biofouling of the membrane, allows the system 500 to autonomously and independently determine when the membrane needs to be clean or changed.

The molecule detection sensor 550 is connected to the global controller 520 so that all the data collected by the sensor is transmitted (in a wireless or wired manner) to the controller. The global controller may store in its memory data collected during various experiments, which are indicative of the presence of a specific molecule for each known bacteria for a given membrane. Also, based on previous experiments, it is possible to store tables in the global controller that are indicative of the amount of a certain molecule (enzyme) which is generated by a certain bacteria, that would indicate that the membrane is clogged and needs to be clean. Thus, the global controller is capable of receiving the readings from the molecule detection sensor 550, identify the type of the detected molecules and their amount, and correlate them with the table values discussed above. When the amount of a certain enzyme (or other molecules) is larger than a given threshold stored in these tables, the global controller 520 determines that the membrane needs to be cleaned or replaced, and sends an alarm or message to the operator of the plant to that effect.

After the detection performed by the molecule detection sensor 550 is completed, the membrane module 502 and the loop 530 need to be cleaned up from the reagent 534 and the fluorescent product 535. The global controller 520 instructs valve S6 to open, to allow a fluid 542 (for example, water) from a flush fluid storage tank 544 to enter the loop 530 along inlet pipe P5. At the same time, the global controller 520 configures valve S6 to close pipe P6, which connects valve S6 to valve S5. At the same time, the global controller 520 configures valve S5 to close fluid access to pipe P6 and allow fluid access along pipe P7. Pipe P7 is connected to a waste container 546. Pump 540 circulates the fluid 542 through the loop 530, from valve S6, through the pump 540, valve S7 (which is configured now by the global controller to prevent access to the dosage device 532), molecule detection sensor 550, valve S3, membrane module 502, valve S4, valve S5, and pipe P7. This action pumps the fluid with the reagent 534 and fluorescent product 535 into the waste tank 546, cleaning the loop.

At the end of this cleaning stage, the global controller 520 reconfigures valves S1 and S2 to allow fluid flow through pipes P2 and P8, and reconfigures valves S3 and S4 to prevent the feed 103 to enter the loop 530. As a result of this step, the membrane module 502 is brought back on-line, i.e., to experience again the feed 103 as the plant membrane 110 of the plant 100.

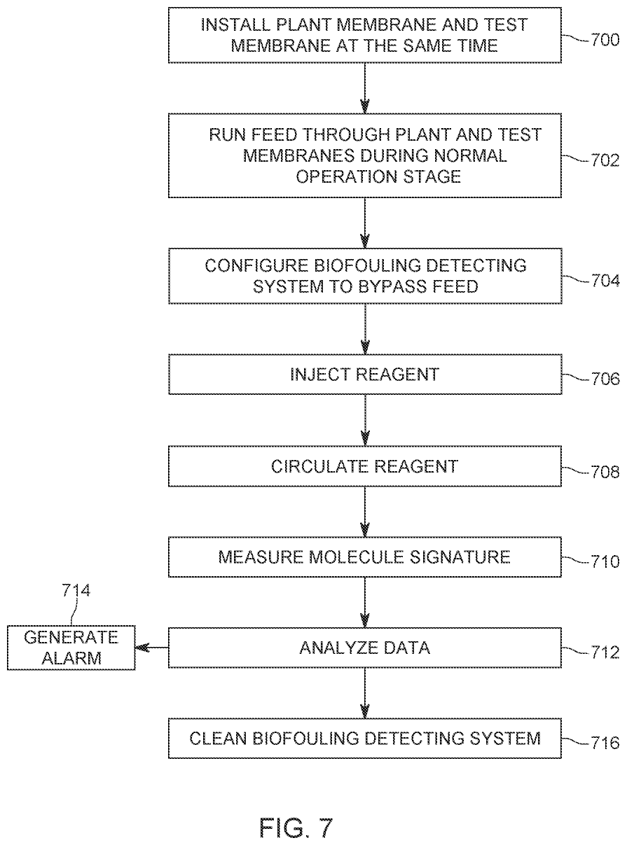

The efficiency of the cleaning stage discussed above was tested by injecting a known concentration of a fluorogen (which has a discreet signal) and cycling it within the module, followed by a flush cycle that removes all the traces of the fluorogen. As shown in FIG. 6, the known concentration 600 of fluorogen was detected by the molecule detection sensor 550 each time this process was repeated. When the cleaning stage was activated, the system removed the fluorogen, as shown by the very low value 602 of the recorded signal. The peaks 604 correspond to the instant when the fluorogen is injected into the loop 530, and thus, the molecule detection sensors 550 makes an initial high detection of the concentrated fluorogen. However, as the time passes and the pump 540 spreads the fluorogen uniformly in the loop, the almost constant value 600 is read. This graph indicates that the biofouling detecting system 500 correctly identifies the foreign substance present in the loop, measures it, and then removes the foreign substance during the cleaning stage. FIG. 6 also shows that these stages were repeated multiple times and each time the system correctly determined (same intensity of the signal) the foreign substance and then flushed it out of the system. All these operations were coordinated by the global controller 520, with no human intervention.

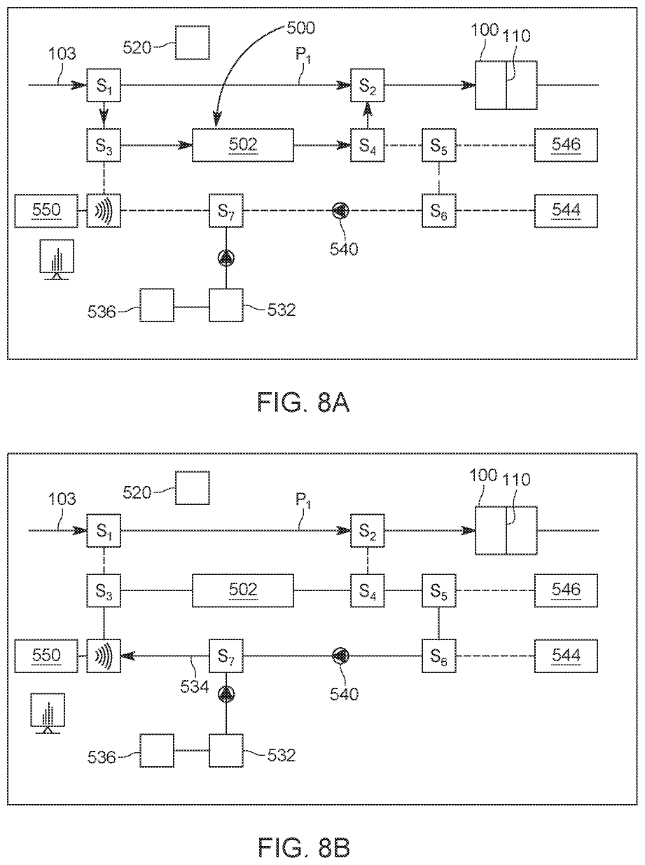

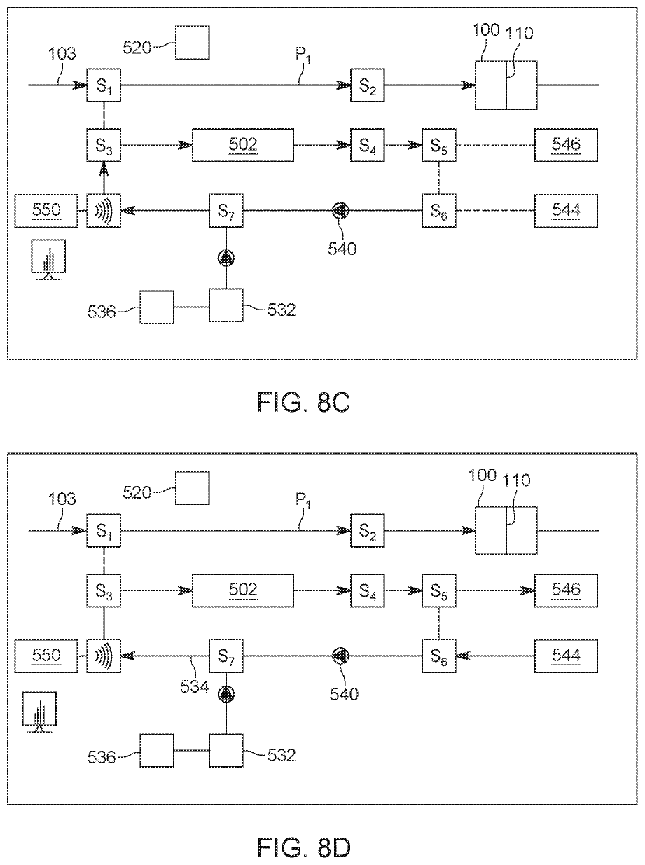

A full cycle of the biofouling detecting system 500 is now discussed with regard to FIGS. 7 to 8D. FIG. 7 is a flowchart that illustrates a method for determining when a membrane in a plant needs to be cleaned. The method starts in step 700 by having the plant membrane 110 of the plant 100 and the membrane 504 (called herein test membrane) of the biofouling detecting system 500 installed at the same time, i.e., with the same level of cleanliness. In step 702, a feed 103 is run in parallel and simultaneously through the plant membrane 110 and the test membrane 504 of the biofouling detecting system 500. The plant 100 and biofouling detecting system 500 are operationally illustrated in FIG. 8A. This is the normal operation stage of the system. In step 704, the global controller 520 decides to test the quality of the test membrane 504. This step can happen at given time intervals, for example, in the order of minutes or hours. In one application, the system can test the biofouling of the test membrane in less than 30 minutes. In another application, the system can do the testing in less than 15 minutes. For these times, the global controller can be programmed to repeat the testing every 30 minutes. In still another application, the global controller can be programmed to repeat the testing every hour. One skilled in the art would understand that these times are exemplary and other times may be used.

Next, the system enters the initiation stage, which is illustrated in FIG. 8B, and includes directing the feed to by-pass the biofouling detecting system 500. When the decision to test the quality of the test membrane 504 is made, the global controller 520 instructs the valve S1 to block the flow of the feed 103 to valve S3, and to allow the feed 103 to flow only along pipe P1, to the plant 100. Further, the global controller 520 instructs valve S2 to block the flow of the feed from valve S4 back to the main pipe P1, and to allow the feed to flow only along the pipe P1, toward the plant 100. These actions are illustrated with dash lines in FIG. 8B, between the various valves, indicating that those pipes are closed. It is also noted that valves S5 and S6 are not allowing fluid communication to flush fluid storage tank 544 and waste tank 546 in both FIGS. 8A and 8B. In addition, FIG. 8A shows that valves S3 and S4 are not allowing the feed 103 to flow to loop 530 and valves S5 to S7 are not allowing any fluid flow, i.e., they are off.

Returning to the initiation stage illustrated in FIG. 8B, the global controller 520 instructs in step 706 valve S7 to fluidly connect the dosing device 532 to the loop 530, so that the reagent 534 hold by the storage tank 536 is injected into the loop 530. The amount of reagent 534 injected into the loop 530 is controlled by the global controller 520, which controls the dosing device 532. In one application, the reagent is injected for a couple of seconds into the loop 530. In one embodiment, the reagent is injected for less than 10 s. Therefore, the global controller 520 can control for total volume dispensed or time spent dispensing.

The pump 540 is activated in step 708 for circulating the reagent through the entire loop and allowing the reagent to interact with the enzymes (or other biological products) that were generated at the membrane module 502, by the various biological life present on the test membrane 504. The system enters now a sampling stage, during which the reagent is circulated for about a hundred to a thousand seconds for obtaining a homogenous mixture/compound. This homogenous mixture/compound can be manipulated by modulating the pump 540. In step 710, the global controller 520 instructs the molecule detection sensor 550 to measure the molecules' signatures. If the molecule detection sensor 550 is a fluorescent molecule, then a fluorescent signal is collected. Other type of data may be recorded depending on the implementation of the molecule detection sensor 550. Data is transmitted to the global controller 520 and analyzed in step 712. Depending on the result of this analysis, e.g., if the detected type and amount of a molecule is higher than a given threshold stored in the global controller, the global controller may generate an alarm in step 714. The alarm may be delivered in any form to the operator of the plant, for example, sound, flashing light, a text message, an email, etc.

In step 716, the global controller 520 instructs the system 500 to enter a cleaning stage, to flush out the reagent and the compounds that resulted from the interaction of the reagent with the biological material produced on the test membrane. To achieve this result, the global controller 520 stops the dosing device 532, to prevent further injection of the reagent 534. Also, the global controller 520 configures valve S7 to interrupt fluid communication between the loop 530 and the dosing device 532. Further, the global controller 520 (1) configures valve S6 to allow a fluid from the flush fluid storage tank 544 to enter the loop, (2) interrupts fluid communication between valves S5 and S6, (3) continues to run pump 540 to circulate the flush fluid through the loop 530, and (4) configures valve S5 to allow fluid communication with waste tank 546, as illustrate in FIG. 8D. In this way, the newly injected flush fluid from the fluid storage tank 544 is allowed to circulate through the entire loop 530, and then to exit into the waste tank 546. This process removes most of the reagent and associated compounds as discussed above with regard to FIG. 6. This step may last a couple of minutes, for example, less than 5 minutes. At the end of this step, the global controller 520 may instruct the molecule detection sensor 550 to perform another analysis of the fluid passing by and, based on this result, the global controller 520 then determines if the fluid inside the loop is clean. If the result of this determination is yes, the valves S1 to S7 are reconfigured for the normal operation stage shown in FIG. 8A, and then the method returns to step 702. If the result is no, the global controller 520 may run longer the cleaning stage before returning to the normal operation stage. Additionally, instead of a fluid storage tank 544, inlet water originating from the main process can be used to perform the cleaning procedure.

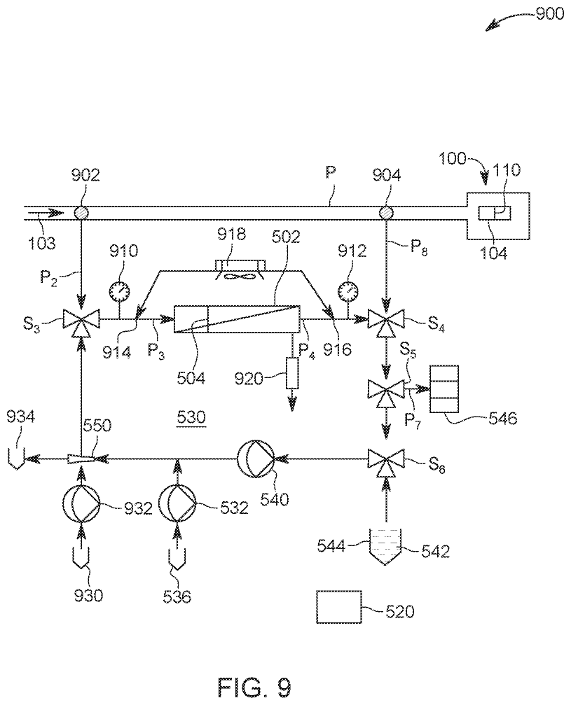

The biofouling detecting system may be implemented differently, for example, as illustrated in FIG. 9. In this embodiment, the biofouling detecting system 900 has the valves S1 and S2 removed. An inlet 902 and outlet 904 are connected to the main pipe P1, that supplies the feed 103 to the plant 100. Valves S3 and S4 are configured to allow the feed 103 to move through the membrane module 502. However, the global controller 520 can control these valves to prevent the feed 103 from entering the loop 530, when the reagent is injected during the initiation stage. First and second flowmeters 910 and 912 are added in this embodiment along pipes P3 and P4 to evaluate a flow of the fluid through the membrane module 502. Further, pressure sensors 914 and 916 are added on the same pipes so that a pressure differential could be estimated at differential pressure sensor 918. Knowing the flow of the feed through or about the test membrane 504 and also the differential pressure across it, makes the global controller 520 to better model, based on the test membrane 504, the conditions experienced by the plant membrane 110, and thus, to better estimate the actual status of the plant membrane.

To further improve the simulation conditions, the permeate is removed at port 920 from the membrane module 502, similar to the actual plant filtration unit 104. The normal operation stage, initiation stage and sampling stage discussed above with regard to FIGS. 8A to 8D are also implemented for this embodiment, and thus their description is omitted. However, the cleaning stage is different for this embodiment. For the cleaning stage, valves S5 and S6 are controlled by the global controller 520 so that a flush fluid 542 from a flush fluid storage tank 544 moves along the entire loop 530, except for the pipe between valves S5 and S6. Valve S5 allows the flush fluid 542 to exit the loop 530 into a waste tank 546, but does not allow it to return to valve S6.

In this embodiment, the molecule detection sensor 550 has its own cleaning system that includes a storage tank 930 (e.g., a carboy or any known storage device), a pump 932, and a waste tank 934. During the cleaning stage, the global controller 520 coordinates, in addition to cleaning the loop 530, the cleaning of the molecule detection sensor 550, independent of the loop 530. The cleaning of the molecule detection sensor 550 implies pumping a fluid from the storage tank 930, with the pump 932, through the molecule detection sensor 550 to remove any reagent or byproduct from the test membrane. This fluid is then discarded into the waste tank 934. Thus, the fluid that flows into the loop 530 due to the pump 540 is independent of the fluid that flows through the molecule detection sensor 550, due to the pump 932. This means that the molecule detection sensor's cleaning is now separated from the loop's cleaning. However, both of these sub-stages are still controlled by the global controller 520.

One advantage of the biofouling detecting system discussed herein is that it allows enzymatic quantification to be deduced based on the rate of the reaction, as judged by a signal generation over a specified period of time. This is different from the passive incubation method of PCT/IB2017/055042. The data for the present embodiments is automatically collected for analysis and the process is agnostic to the medium and reporter agent used. While the method discussed above with regard to FIG. 7 was applied to a plant that treats a feed with a membrane, the biofouling detecting system used in the method can be expanded to test other flowing systems that utilize signal generating molecules introduced and measured at discreet time points. For example, the system might be usable in the biocorrosion space, as well as monitoring of chemical composition of liquid systems.

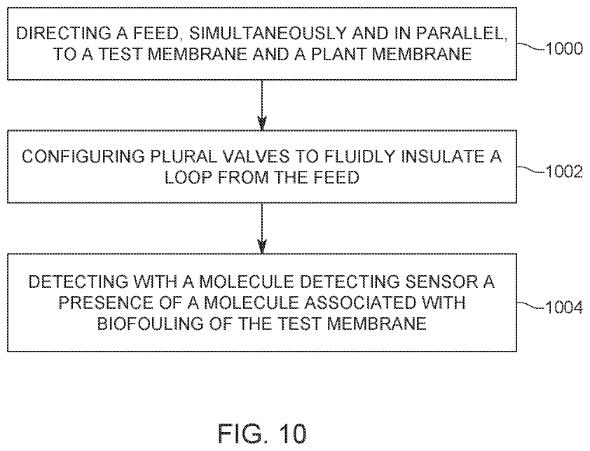

A method for determining when a plant membrane needs cleaning is illustrated in FIG. 10. The method includes a step 1000 of directing a feed, simultaneously and in parallel, over a test membrane and a plant membrane, a step 1002 of configuring plural valves S3-S7 to fluidly insulate a loop from the feed, and a step 1004 of detecting with a molecule detecting sensor a presence of a molecule associated with the test membrane. The loop includes the plural valves, the molecule detecting sensor, a dosage device, and a pump.

The steps of configuring and detecting are performed autonomously and independently by a global controller. The method may also include a step of instructing the dosage device to inject a reagent into the loop, and a step of instructing the pump to circulate the reagent through the loop. The method may also include a step of instructing the molecule detection sensor to determine the molecule associated with the test membrane, a step of receiving a measured signal at the global controller, and a step of sending an alarm when the test membrane needs to be cleaned. The method may also include a step of switching off the dosing device, opening a valve to allow a fluid from a flush fluid storage tank to enter the loop, and opening another valve to allow the fluid to exit the loop into a waste tank, to complete a cleaning stage of the molecule detecting sensor and the test membrane.

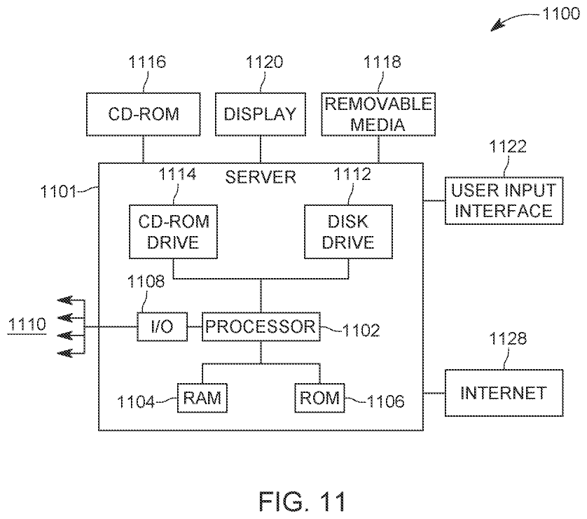

The above-discussed procedures and methods may be implemented in a computing device or controller 1100 as illustrated in FIG. 11. Controller 1100 corresponds to the global controller 520. Hardware, firmware, software or a combination thereof may be used to perform the various steps and operations described herein. Exemplary computing device 1100 suitable for performing the activities described in the exemplary embodiments may include a server 1101. Such a server 1101 may include a central processor (CPU) 1102 coupled to a random access memory (RAM) 1104 and to a read-only memory (ROM) 1106. ROM 1106 may also be other types of storage media to store programs, such as programmable ROM (PROM), erasable PROM (EPROM), etc. Processor 1102 may communicate with other internal and external components through input/output (I/O) circuitry 1108 and bussing 1110 to provide control signals and the like. Processor 1102 carries out a variety of functions as are known in the art, as dictated by software and/or firmware instructions.

Server 1101 may also include one or more data storage devices, including hard drives 1112, CD-ROM drives 1114 and other hardware capable of reading and/or storing information, such as DVD, etc. In one embodiment, software for carrying out the above-discussed steps may be stored and distributed on a CD-ROM or DVD 1116, a USB storage device 1118 or other form of media capable of portably storing information. These storage media may be inserted into, and read by, devices such as CD-ROM drive 1114, disk drive 1112, etc. Server 1101 may be coupled to a display 1120, which may be any type of known display or presentation screen, such as LCD, plasma display, cathode ray tube (CRT), etc. A user input interface 1122 is provided, including one or more user interface mechanisms such as a mouse, keyboard, microphone, touchpad, touch screen, voice-recognition system, etc.

Server 1101 may be coupled to other devices, such as a smart device, e.g., a sensor or any part of the plant 100. The server may be part of a larger network configuration as in a global area network (GAN) such as the Internet 1128, which allows ultimate connection to various landline and/or mobile computing devices.

The disclosed embodiments provide a biofouling detecting system that is capable of automatically determining when a plant membrane needs maintenance, based on observations of a test membrane. The embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. An autonomous and independent biofouling detecting system for detecting biofouling associated with a plant membrane based on a test membrane, the biofouling detecting system comprising:
the test membrane, which shares a feed with the plant membrane;
a molecule detecting sensor that detects a presence of a molecule associated with biofouling of the test membrane; and
a global controller that controls a flow of the feed through the test membrane and determines when the test membrane needs cleaning.

2. The biofouling detecting system of claim 1, further comprising:
plural valves and pipes that form a closed loop with the molecule detecting sensor and the test membrane.

3. The biofouling detecting system of claim 2, further comprising:
a pump integrated into the loop and configured to circulate a fluid through the loop as instructed by the global controller.

4. The biofouling detecting system of claim 3, further comprising:
a dosing device that is controlled by the global controller and is configured to inject a reagent into the loop.

5. The biofouling detecting system of claim 4, further comprising:
a flush fluid storage tank connected to the loop.

6. The biofouling detecting system of claim 5, further comprising:
a waste tank connected to the loop.

7. The biofouling detecting system of claim 6, wherein the test membrane is housed by a membrane module, and the membrane module is fluidly connected between first and second valves of the plural valves.

8. The biofouling detecting system of claim 7, wherein a third valve of the plural valves fluidly connects the flush fluid tank storage to the loop, a fourth valve of the plural valves fluidly connects the waste tank to the loop, and a fifth valve of the plural valves fluidly connects the dosage pump to the loop.

9. The biofouling detecting system of claim 8, wherein the global controller configures the plural valves to suppress the feed of the plant membrane to enter the loop during an initiation stage.

10. The biofouling detecting system of claim 9, wherein the global controller instructs the dosage device to inject a reagent into the loop and instructs the pump to circulate the reagent through the loop.

11. The biofouling detecting system of claim 10, wherein the global controller instructs the molecule detection sensor to determine the molecule associated with the test membrane and to transmit a measured signal to the global controller.

12. The biofouling detecting system of claim 11, wherein the global controller generates an alarm when an amount of the molecule is determined to be higher than a given threshold.

13. The biofouling detecting system of claim 11, wherein the global controller initiates a cleaning stage by switching off the dosing device, opening the third valve to allow a fluid from the flush fluid storage tank to enter the loop, and opening the fourth valve to allow the fluid to exit the loop into the waste tank, after the fluid was circulated by the pump through the molecule detecting sensor and the membrane module.

14. An autonomous and independent biofouling detecting system for detecting biofouling associated with a plant membrane, the biofouling detecting system comprising:
a test membrane that shares a feed with the plant membrane;
a molecule detecting sensor that detects a presence of a molecule associated with biofouling of the test membrane; and
a global controller that controls a flow of the feed through the test membrane and generates an alarm when the test membrane needs cleaning.

15. The biofouling detecting system of claim 14, further comprising:
a flowmeter that measures an amount of the feed passing the test membrane; and
a differential pressure sensor that measures a pressure difference across the test membrane,
wherein the global controller uses readings from the flowmeter and the differential pressure sensor to generate the alarm.

16. The biofouling detecting system of claim 14, further comprising:
a cleaning system dedicated exclusively to cleaning the molecule detecting sensor.

17. A method for determining when a plant membrane needs cleaning, the method comprising:
directing a feed, simultaneously and in parallel, to a test membrane and a plant membrane;
configuring plural valves (S3-S7) to fluidly insulate a loop from the feed; and
detecting with a molecule detecting sensor a presence of a molecule associated with biofouling of the test membrane,
wherein the loop includes the plural valves, the molecule detecting sensor, a dosage device, and a pump.

18. The method of claim 17, wherein the steps of configuring and detecting are performed autonomously and independently by a global controller.

19. The method of claim 18, further comprising:
instructing the dosage device to inject a reagent into the loop; and
instructing the pump to circulate the reagent through the loop.

20. The method of claim 19, further comprising:
instructing the molecule detection sensor to determine the molecule associated with the test membrane;
receiving a measured signal at the global controller; and
generating an alarm when the test membrane needs to be cleaned.

21. The method of claim 20, further comprising:
switching off the dosing device;
opening a valve to allow a fluid from a flush fluid storage tank to enter the loop; and
opening another valve to allow the fluid to exit the loop into a waste tank, to complete a cleaning stage of the molecule detecting sensor and the test membrane.
